(19) United States
(12) Patent Application Publication
(10) Pub. No.: US 2025/0106312 A1
(43) Pub. Date: Mar. 27, 2025

(54) SYSTEMS AND METHODS FOR THE ENCOURAGEMENT OF ENVIRONMENTALLY SUSTAINABLE BEHAVIOUR

(71) Applicant: The Toronto-Dominion Bank, Toronto (CA)

(72) Inventors: David Samuel TAX, Toronto (CA); Milos DUNJIC, Oakville (CA); Pranay GUPTA, CANADA (CA); Hitesh BAJAJ, Duluth, GA (US); Kushank RASTOGI, Toronto (CA); Abeera AGUIAR, Princeton Junction, NJ (US)

(73) Assignee: The Toronto-Dominion Bank, Toronto, ON (CA)

(21) Appl. No.: 18/472,902

(22) Filed: Sep. 22, 2023

(51) Int. Cl. H04L 69/18; G06Q 30/018

(52) U.S. Cl. CPC H04L 69/18; G06Q 30/018

(57) ABSTRACT

Systems and methods for the encouragement of environmentally sustainable behaviour are provided. A system may assign, in a second memory, an environmental score to each of a plurality of transfer protocol options. A rank may then be determined for each of the plurality of transfer protocol options based on the assigned environmental scores. In response to detecting an event associated with a first storage location, the system may filter the plurality of transfer protocol options to exclude at least a first transfer protocol option having a relatively low rank. The system may also generate user interface data identifying at least a second transfer protocol option, the second transfer protocol option having a relatively high rank.

### TECHNICAL FIELD

The present application relates to the encouragement of low-carbon behaviour, and more particularly to the encouragement of the use of low-carbon data transfer options.

### BACKGROUND

In recent years, there has been an increasing interest by organizations and individuals in sustainability—to giving preference to behaviour that generates positive environmental outcomes. Organizations and individuals have become increasingly interested in considering the carbon cost of various products and behaviours.

At present, it can be challenging to determine the environmental impact associated with various products and behaviours. For example, it can be challenging to determine the carbon cost associated with various protocols for transferring data. Very often, carbon costs are not associated with data transfer protocols. Where carbon costs have been associated with data transfer protocols, the relative costs are not compared, and this information is not provided to consumers in an actionable way.

Improvements to the field are desired.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level operation diagram of an example computing device;

FIG. 3 depicts an example simplified software organization of the example computing device of FIG. 2;

FIG. 4 shows the front of the client device of FIG. 1;

FIG. 5 illustrates a method for generating user interface data identifying at least a second transfer protocol option, in accordance with embodiments of the present disclosure;

FIG. 6 illustrates a table listing a plurality of transfer protocol options and their associated environmental scores and ranks, in accordance with embodiments of the present disclosure;

FIG. 7 illustrates a first example user interface, in accordance with embodiments of the present disclosure;

FIG. 8 illustrates a second example user interface, in accordance with embodiments of the present disclosure;

FIG. 9 illustrates a third example user interface, in accordance with embodiments of the present disclosure; and

FIG. 10 illustrates a fourth example user interface, in accordance with embodiments of the present disclosure.

Like reference numerals are used in the drawings to denote like elements and features.

### DETAILED DESCRIPTION OF VARIOUS EMBODIMENTS

Consumers may lack awareness of the relative environmental impact of various data transfer options. For example, a consumer may lack awareness of a differential in carbon cost between one streaming provider option and another streaming provider option, or between one file transfer protocol option and another file transfer protocol option. The environmental impact associated with various data transfer protocols may be determined by a plethora of factors not observable to a consumer, such as, for example, the expected number of on-site workers required to effect a transfer protocol option, including the expected number of on-site workers required perform fraud detection in connection with a transfer protocol option. The environmental impact may also be determined by considering the expected amount of transportation required to effect a transfer protocol option.

In order to encourage a consumer to select a low-carbon data transfer protocol option, environmental scores may be assigned to a plurality of transfer protocol options. A ranking of the plurality of data transfer options may then be determined based on the environmental scores. A consumer may then be notified of one or more higher-ranking transfer protocol options in a variety of ways, either before or after a transfer protocol option is effected.

In accordance with one aspect of the present disclosure, there is provided a computing system. The computing system comprises a communications module, a processor coupled to the communications module, and a first memory coupled to the processor. The first memory stores processor-executable instructions which, when executed, configure the system to: assign, in a second memory, an environmental score to each of a plurality of transfer protocol options; determine a rank for each of the plurality of transfer protocol options based on the environmental scores assigned to the plurality of transfer protocol options; and detect an event associated with a first storage location. In response to detecting the event, the system is further configured to filter the plurality of transfer protocol options to exclude at least a first transfer protocol option having a relatively low rank and generate user interface data identifying at least a second transfer protocol option, the second transfer protocol option having a relatively high rank.

In some implementations, detecting the event includes receiving an instruction to display a listing of one or more transfer protocol options. The system is further caused to provide the user interface data to a client device associated with the first storage location. The user interface data causes the client device to display a user interface that includes a listing of selectable options, the listing of selectable options including at least the second transfer protocol option.

In some implementations, the listing of selectable options further includes one or more additional transfer protocol options of the plurality of transfer protocol options. The rank of each of the one or more additional transfer protocol options is above a certain threshold.

In some implementations, prior to detecting the event, the system is further caused to determine that the first storage location is associated with a request to suppress, from the listing of selectable options, one or more transfer protocol options having a low environmental score.

In some implementations, detecting the event includes receiving an instruction to transfer data resources from the first storage location using the first transfer protocol option. The system is further caused to provide the user interface data to a client device associated with the first storage location. The user interface data causes the client device to display a notification identifying at least the second transfer protocol option.

In some implementations, the notification further identifies one or more additional transfer protocol options of the plurality of transfer protocol options, and the rank of each of the one or more additional transfer protocol options is above a certain threshold.

In some implementations, detecting the event includes receiving an instruction to transfer data resources from the first storage location to a second storage location. The system is further caused to provide the user interface data to a client device associated with the storage first location and initiate a transfer of the data resources from the first storage location to the second storage location using the second transfer protocol option. The rank of the second transfer protocol option is equal to one.

In some implementations, prior to detecting the event, the system is further caused to determine that the first storage location is associated with a request to automatically select, from the plurality of transfer protocol options, a transfer protocol option having a highest rank.

In some implementations, detecting the event includes detecting a transfer of data resources from the first storage location using the first transfer protocol option. The system is further caused to provide the user interface data to a client device associated with the first storage location. The user interface data causes the client device to display a notification identifying at least the second transfer protocol option.

In some implementations, the environmental score assigned to each of the plurality of transfer protocol options is based upon an expected carbon footprint associated with use of each of the plurality of transfer protocol options.

In some implementations, the expected carbon footprint is based upon one or more of an expected number of persons required to effect each of the transfer protocol options, an expected amount of transportation required to effect each of the transfer protocol options, or an expected use of biometric authentication associated with each of the transfer protocol options.

In accordance with another aspect of the present disclosure, there is provided a computer-implemented method. The computer-implemented method comprises assigning, in a memory, an environmental score to each of a plurality of transfer protocol options, determining a rank for each of the plurality of transfer protocol options based on the environmental scores assigned to the plurality of transfer protocol options, and detecting an event associated with a first storage location. In response to detecting the event, the method further comprises filtering the plurality of transfer protocol options to exclude at least a first transfer protocol option having a relatively low rank and generating user interface data identifying at least a second transfer protocol option, the second transfer protocol option having a relatively high rank.

In some implementations, detecting the event includes receiving an instruction to display a listing of one or more transfer protocol options. The method further comprises providing the user interface data to a client device associated with the first storage location. The user interface data causes the client device to display a user interface that includes a listing of selectable options, the listing of selectable options including at least the second transfer protocol option.

In some implementations, the listing of selectable options further includes one or more additional transfer protocol options of the plurality of transfer protocol options. The rank of each of the one or more additional transfer protocol options is above a threshold.

In some implementations, prior to detecting the event, the method further comprises determining that the first storage location is associated with a request to suppress, from the listing of selectable options, one or more transfer protocol options having a low environmental score.

In some implementations, detecting the event includes receiving an instruction to transfer data resources from the first storage location using the first transfer protocol option. The method further comprises providing the user interface data to a client device associated with the first storage location, the user interface data causing the client device to display a notification identifying at least the second transfer protocol option.

In some implementations, the notification further identifies one or more additional transfer protocol options of the plurality of transfer protocol options, and the rank of each of the one or more additional transfer protocol options is above a threshold.

In some implementations, detecting the event includes receiving an instruction to transfer data resources from the first storage location to a second storage location. The method further comprises providing the user interface data to a client device associated with the storage first location and initiating a transfer of the data resources from the first storage location to the second storage location using the second transfer protocol option. The rank of the second transfer protocol option is equal to one.

In some implementations, prior to detecting the event, the method further comprises determining that the first storage location is associated with a request to automatically select, from the plurality of transfer protocol options, a transfer protocol option having a highest rank.

In accordance with another aspect of the present application, there is provided a non-transitory computer-readable storage medium. The non-transitory computer-readable storage medium comprises processor-executable instructions which, when executed, configure a processor to assign, in a memory, an environmental score to each of a plurality of transfer protocol options, determine a rank for each of the plurality of transfer protocol options based on the environmental scores assigned to the plurality of transfer protocol options, and detect an event associated with a first storage location. In response to detecting the event, the processor is further configured to filter the plurality of transfer protocol options to exclude at least a first transfer protocol option having a relatively low rank and generate user interface data identifying at least a second transfer protocol option, the second transfer protocol option having a relatively high rank.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

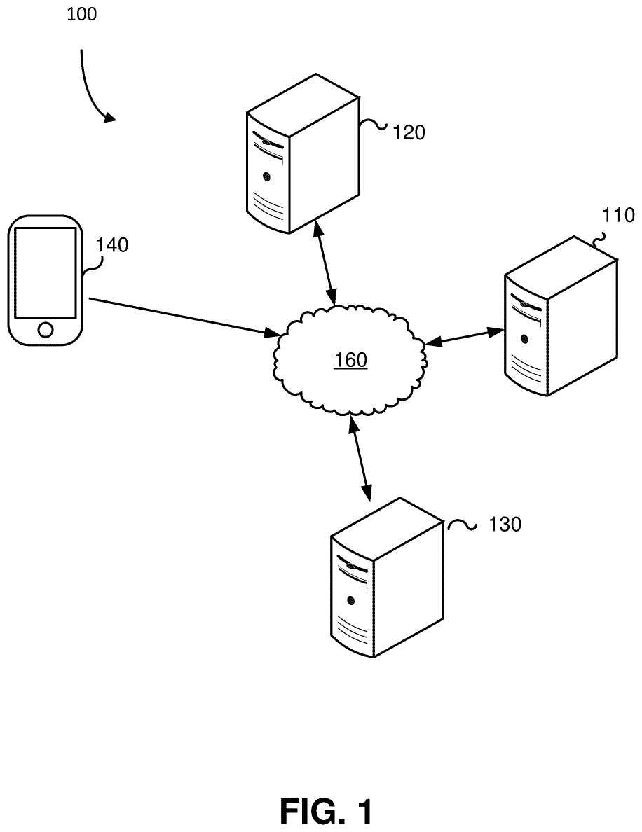

FIG. 1 is a schematic operation diagram illustrating an operating environment of an example embodiment.

As illustrated, the example operating environment 100 includes a first resource management system 110, a second resource management system 120, a transfer rail system 130, and a client device 140 in communication via a network 160.

Each of the first resource management system 110, the second resource management system 120, the transfer rail system 130, and the client device 140 may be in geographically disparate locations. Put differently, one or more of the first resource management system 110, the second resource management system 120, the transfer rail system 130, and the client device 140 may be remote to others of the first resource management system 110, the second resource management system 120, the transfer rail system 130, and the client device 140.

The first resource management system 110, the second resource management system 120, the transfer rail system 130 and the client device 140 are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The first and second resource management systems 110, 120 may each be a single server, multiple servers, a server farm, or any other such arrangement of computing devices to implement computing server-like functionality. In some embodiments, the first and second resource management systems 110, 120 may track, manage, and maintain resources. The resources may, for example, be computer code, spreadsheet data, and/or database information and may include image, text, audio and/or video files. Additionally or alternatively, the resources may be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economics of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

In some embodiments, the first and second resource management systems 110, 120 may track, manage, and maintain owned resources belonging to respective entities. The resources may be represented in a database, and the database may be provided in secure storage(s). The secure storage(s) may be provided internally within the first and second resource management systems 110, 120 or externally. The secure storage(s) may, for example, be provided remotely from the first and second resource management systems 110, 120. For example, the secure storage(s) may include one or more data centers. The data centers may, for example, store data with bank-grade security.

In some embodiments, the first and second resource management systems 110, 120 may include records for a plurality of resource accounts and at least some of the records may define a quantity of resources. A first entity may be associated with one or more accounts storing or otherwise reflecting owned resources, i.e., a first owned resource account. The records may reflect a first quantity of stored resources that are associated with the first entity. Such resources may include owned resources. The amount of resources associated with the first entity may be reflected by a first resource definition defined in an associated first resource record. The first resource definition may be or include a first balance defined in an associated first resource record; for example a first bank balance. The first resource definition may be recorded in a first storage location.

A second entity may be associated with one or more accounts storing or otherwise reflecting owned resources, i.e., an owned resource account. The records may reflect a second quantity of stored resources that are associated with the second entity. Such resources may include owned resources. The amount of resources associated with the second entity may be reflected by a second resource definition defined in an associated second resource record. The second resource definition may be or include a second balance defined in an associated second record; for example a second bank balance.

In some embodiments, the first and second resource management systems 110, 120 may be the same system.

As also shown in FIG. 1, the example operating environment 100 may include one or more transfer rail systems 130. The transfer rail system 130 may be a computing system that facilitates electronic transfer of financial resources and may, in at least some embodiments, be referred to as a payment rail system. By way of example, the transfer rail system 130 may be an electronic funds transfer (EFT) system, a wire transfer system, a real time rail transfer (RTR) system and/or an email money transfer (EMT) system. The transfer rail system 130 may be or include one or more of a Visa™, Mastercard™, American Express™, or other value transfer card (e.g., credit card) rail. The request to transfer resources may be a request to transfer data such as, for example, units of value. The units of value may include a quantity of currency. In some embodiments where the transfer rail system 130 is a computing system that facilitates electronic transfer of financial resources, the first and second resource management systems 110, 120 may be, for example, computer systems associated with one of more financial institutions, such as a bank.

In some embodiments, the client device may be used to request a computing operation, such as a resource transfer, to be facilitated by the transfer rail system 130. The resource transfer may, for example, involve a transfer of data, via the transfer rail system 130, between a first data record at the first resource management system 110 associated with a first account at the first resource management system 110 and a destination data record associated with a destination account at the second resource management system 120. The first resource account may belong to an entity operating the client device. The data involved in the resource transfer may, for example, be units of value and the records involved in the resource transfer may be adjusted in related or corresponding manners. For example, during a resource transfer, a record associated with an intended recipient (i.e., transferee) of the transfer may be adjusted to reflect an increase in value resulting from the transfer, whereas the record associated with the entity (i.e., transferor) initiating the transfer may be adjusted to reflect a decrease in value which is at least as large as the increase in value applied to the record associated with the recipient.

The client device 140 is also a computing device. In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be associated with an entity, such as a user or client, having resources associated with the first resource management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

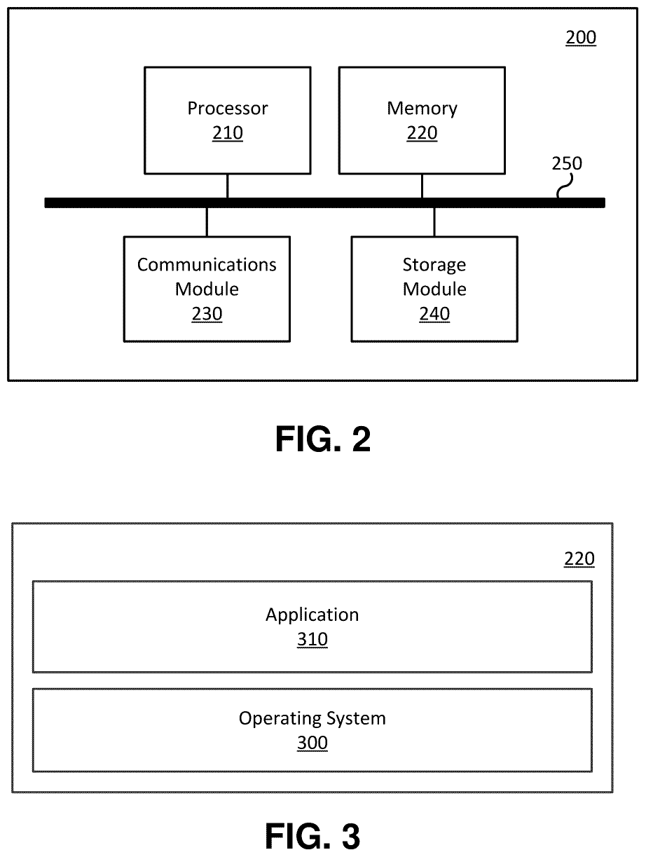

Referring now to FIG. 2, a high-level operation diagram of an example computing device 200 will now be described. The example computing device 200 may be exemplary of the first resource management system 110, the second resource management system 120, the transfer rail system 130, and/or the client device 140.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200. The memory 220 may be described as a first memory.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 will include other components apart from those illustrated in FIG. 2 and the specific component set may differ based on whether the example computing device 200 is operating as the first resource account management system, the client device, the second resource account management system, and/or the transfer rail system. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Linux™, Microsoft™, Windows™, Apple™, Apple OSX™, Android™ or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the first resource account management system, the client device, the second resource account management system, and/or the transfer rail system.

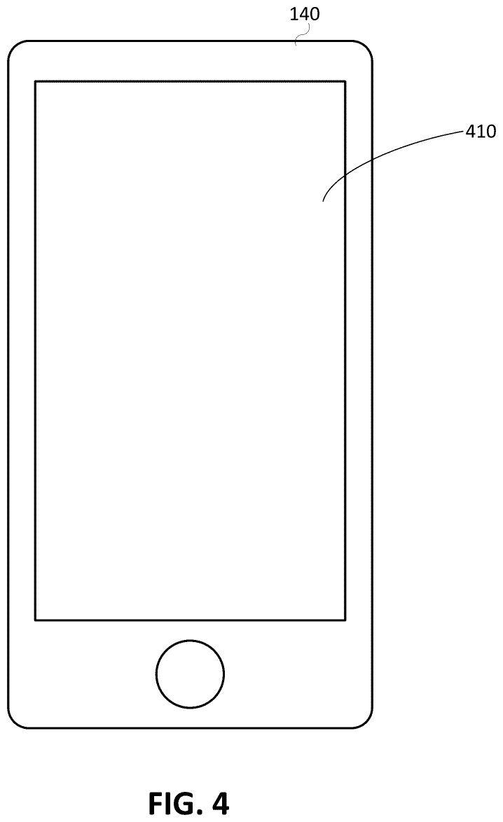

FIG. 4 shows the front of the client device 140 of FIG. 1. The client device 140 may be a personal computing device, such as a smart phone, as shown in FIG. 4. As previously described, the client device 140 may be a computing device of another type such as a laptop computer, a desktop computer, a tablet computer, a notebook computer, a hand-held computer, a personal digital assistant, a portable navigation device, a mobile phone, a wearable computing device.

As illustrated, the front of the client device 140 includes a display 410. The display 410 is a module of the smart phone embodiment of the client device 140. The display 410 is for presenting graphics. The display 410 may be, for example, a liquid crystal display (LCD). In addition to being an output device, the display 410 may also be an input device. For example, the display 410 may allow touch input to be provided to the client device 140. In other words, the display 410 may be a touch sensitive display module. In a particular example, the display 410 may be a capacitive touch screen.

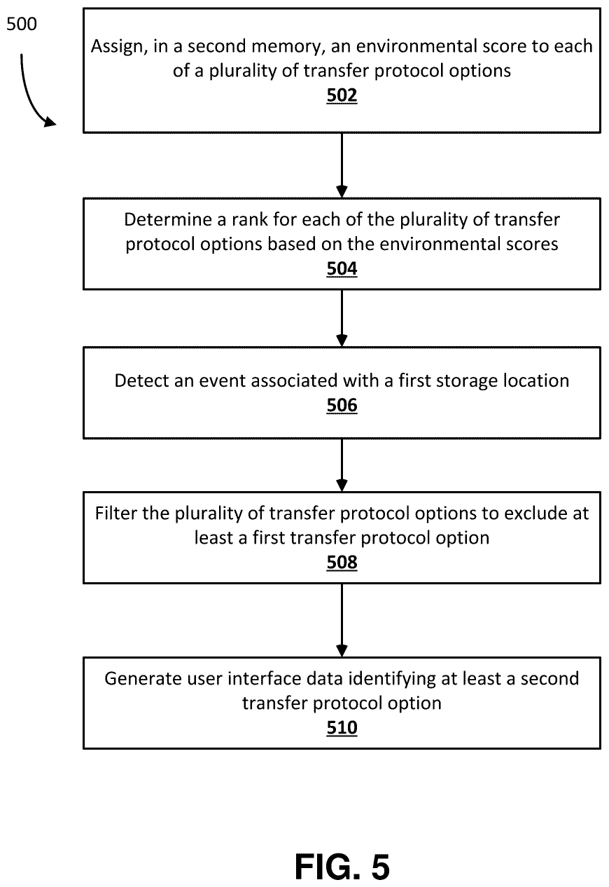

The operation of the first resource management system 110 (FIG. 1) will now be described with reference to the flowchart of FIG. 5 which illustrates a method 500 for generating user interface data identifying at least a second transfer protocol option, in accordance with embodiments of the present disclosure. Operations 502 and onward are performed by one or more processors of a computing device, such as for example the processor 210 of a suitably configured instance of the example computing device 200, executing software such as, for example, a suitable instance of the application 310.

At the operation 502, the system assigns, in a second memory, an environmental score to each of a plurality of transfer protocol options. The second memory may, for example, form part of the storage module 240 (FIG. 2) and/or form part of a database accessible to the storage module 240 (FIG. 2).

In some embodiments, the plurality of transfer protocol options may relate to a plurality of file transfer protocol options, such as, for example, File Transfer Protocol (FTP), File Transfer Protocol Secure (FTPS), Secure File Transfer Protocol (SFTP), Secure Copy Protocol (SCP), Trivial File Transfer Protocol (TFTP), Managed File Transfer (MTP), etc. In some embodiments, the plurality of transfer protocols may relate video streaming protocols, such as Hypertext Transfer Protocol (HTTP) Live Streaming (HLS), Moving Pictures Expert Group Dynamic Adaptive Streaming over HTTP (MPEG-DASH), Secure Reliable Transport (SRT), etc. In such embodiments, the environmental scores may reflect an expected number of on-site workers required to implement the transfer protocol. For example, a transfer protocol may be associated with a number of persons, and a certain percentage of these persons may be work-from-home (WFH) workers. As WFH workers may generate a lower carbon footprint than work-from-office (WFO) workers, an association with a relatively high percentage of WFH workers may be reflected by a relatively high environmental score. As noted, the environmental impact may also be determined by considering an expected amount of transportation required to effect a transfer protocol option.

In some embodiments, the plurality of transfer protocol options may relate to a plurality of payment options, such as, for example, electronic file transfer (EFT), email money transfer (EMT), wire transfer, cheque, bank draft, etc. In such embodiments, environmental scores may reflect the probability of an entity travelling to a physical location to initiate and/or to receive the associated payment. For example, a bank draft and a cheque may be associated with a high probabilities of travel to a physical location, while an EFT, an EMT, and a wire transfer may be associated with low probabilities of travel to a physical location. In some implementations, a bank draft may be associated with a lower environmental score than a cheque as a bank draft may require travel to a physical location while a cheque may be processed via mobile deposit.

As noted, in some embodiments, environmental scores may be associated with a number of on-site persons required to effect the transfer protocol. For example, a greater number of on-site persons may be required to process a cheque and/or a bank draft than are required to process an EFT, an EMT, or a wire transfer. The number of on-site workers required to effect a transfer protocol may correspond to an amount of fraud associated with the transfer protocol. For example, a cheque may be associated with a higher degree of fraud than an EFT, an EMT and/or a wire transfer, and as a result, may require a greater number on on-site workers in order to process.

In some embodiments, the expected use of biometric authentication may affect an environmental score. For example, a transfer protocol option involving the use of biometric authentication may be associated with a smaller number of required associated workers, and thus a smaller number of required on-site workers.

At the operation 504, the system determines a rank for each of the plurality of transfer protocol options based on the environmental scores. In some embodiments, the environmental score assigned to each of the plurality of transfer protocol options may be based upon an expected carbon footprint associated with use of each of the plurality of transfer protocol options.

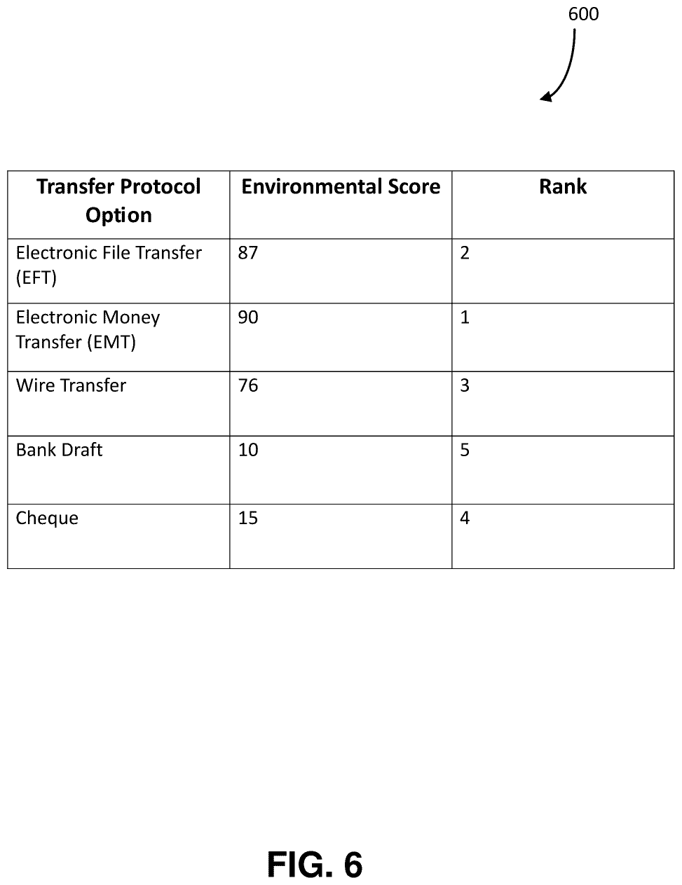

Reference is now made to FIG. 6, which illustrates a table 600 listing a plurality of transfer protocol options and their associated environmental scores and ranks, in accordance with embodiments of the present disclosure. The table 600 may be stored, for example, in a second memory, which may, as noted, form part of the storage module 240 (FIG. 2) and/or form part of a database accessible to the storage module 240 (FIG. 2).

As shown, the plurality of transfer protocol options includes Electronic File Transfer (EFT), Electronic Money Transfer (EMT), Wire Transfer, Bank Draft, and Cheque. Each of the plurality of transfer protocol options are associated with an environmental score. As noted, in some embodiments, the environmental score assigned to each of the plurality of transfer protocol options may be based upon an expected carbon footprint associated with use of each of the plurality of transfer protocol options. In some such embodiments, the expected carbon footprint may be based upon one or more of an expected number of persons required to effect each of the transfer protocol options, an expected amount of transportation required to effect each of the transfer protocol options, or an expected use of biometric authentication associated with each of the transfer protocol options, for example.

As further shown in table 600, an EFT is associated with an environmental score of 87; an EMT is associated with an environmental score of 90, a Wire Transfer is associated with an environmental score of 76, a Bank Draft is associated with an environmental score of 10; and a Cheque is associated with an environmental score of 15. As further shown, each of the plurality of transfer protocol options are associated with a Rank based on the associated Environmental Score. As such, an EFT is associated with a rank of 2; an EMT is associated with a rank of 1; a Wire Transfer is associated with a rank of 3; a Bank Draft is associated with a rank of 5; and a Cheque is associated with a rank of 4.

Returning again to FIG. 5, after the operation 504, the operation 506 is next.

At the operation 506, the system detects an event associated with a first storage location. The event may, for example, include receiving an instruction to display a listing of one or more transfer protocol options. Alternatively, the event may include receiving an instruction to transfer data resources from a first storage location using a first transfer protocol option. Alternatively, the event may include receiving an instruction to transfer data resources from a first storage location to a second storage location. Alternatively, detecting the event may include detecting a transfer of data resources from a first storage location using a first transfer protocol option.

At the operation 508, in response to detecting the event, the system filters the plurality of transfer protocol options to exclude at least a first transfer protocol option having a relatively low rank.

For example, returning again to FIG. 6, the system may filter the plurality of transfer protocol options to exclude the Bank Draft, as the Bank Draft has a rank of 5, which is a relatively low rank. As a further example, the system may filter the plurality of transfer protocol options to further exclude the Cheque, as the cheque has a rank of 4, which is also a relatively low rank.

Returning again to FIG. 5, after the operation 508, the operation 510 is next.

At the operation 510, in further response to detecting the event, the system generates user interface data identifying at least a second transfer protocol option, the second transfer protocol option having a relatively high rank.

The user interface data may be data that may be provided to a client device 140 (FIG. 1) associated with the first storage location. In a first set of embodiments, the user interface data may be configured to cause the client device 140 (FIG. 1) to display a user interface. In a second set of embodiments, the user interface data may be configured to cause the client device 140 (FIG. 1) to display a notification. In a third set of embodiments, the user interface data may be configured to facilitate a data resource transfer using the second transfer protocol option.

Referring again to FIG. 6, it will be noted that of the five transfer protocol options listed in the table 600, i.e., EFT, EMT, Wire Transfer, Bank Draft, and Cheque, two of these options may described as having a relatively high rank and two of these options may be described as having a relatively low rank. The EMT (rank=1) and the ETF (rank=2) may be described as having a relatively high rank, and the Cheque (rank=4) and the Bank Draft (rank=5) may be described as having a relatively low rank. The Wire Transfer (rank=3) may be described as having a mediocre rank.

Returning again to FIG. 5, with reference to the operation 510, the second transfer protocol option may be identified as the EMT, for example, as the EMT has a rank of 1, which is a relatively high rank. The second transfer protocol option may alternatively be identified as the ETF, for example, as the ETF has a rank of 2, which is a relatively high rank.

As noted, in a first set of embodiments, the user interface data may be configured to cause the client device 140 (FIG. 1) to display a user interface. In such embodiments, subsequent to generating the user interface data identifying at least a second transfer protocol option (at the operation 510), the system may then provide the user interface data to a client device 140 (FIG. 1) associated with the first storage location, and the user interface data may cause the client device 140 (FIG. 1) to display a user interface.

In at least some implementations of the first set of embodiments, the provision of the user interface is associated with examples where detecting the event (operation 506) includes receiving an instruction to display a listing of one or more transfer protocol options, the user interface including a listing of selectable options. The listing of selectable options may include at least the second transfer protocol option, the second transfer protocol option having a relatively high rank. In some implementations, the listing of selectable options further includes one or more additional transfer protocol options of the plurality of transfer protocol options, and wherein the rank of each of the one or more additional transfer protocol options is above a certain threshold.

For example, prior to detecting the event (operation 506), the system may determine that the first storage location is associated with a request to suppress, from the listing of selectable options, one or more transfer protocol options having a low environmental score. The instruction to display the listing of one or more transfer options may be associated with a commencement, via the client device, of a transfer of data resources from the first storage location.

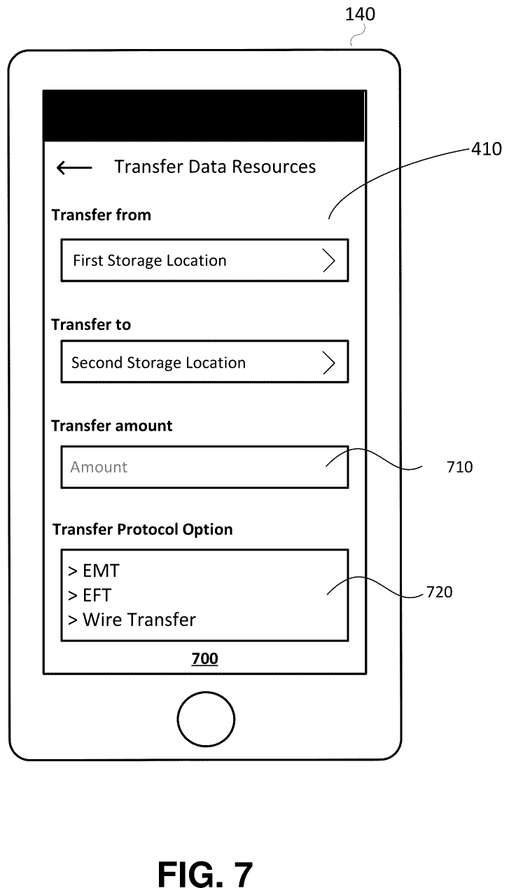

Reference is now made to FIG. 7, which illustrates a first example user interface 700 including a listing of selectable options 720, the listing of selectable options including at least the second transfer protocol option, the second transfer protocol option having a relatively high rank. As noted with reference to the table 600 of FIG. 6, at least two of the listed transfer protocol options may described as having a relatively high rank—the EMT (rank=1) and the ETF (rank=2).

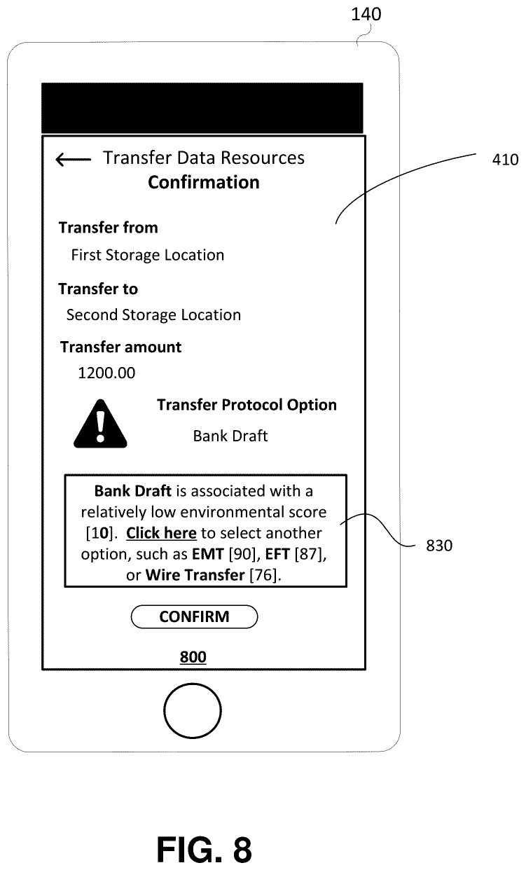

As illustrated by FIG. 7, the display 410 of the client device 140 may present the first example user interface 700. The first example user interface 700 displays a title, “Transfer Data Resources”, and an indication that data resources are to be transferred from a “First Storage Location” to a “Second Storage Location”. A text window 710 for the entry of a desired transfer amount is also displayed. The first example user interface 700 still further displays a listing of selectable options 720 corresponding to a listing of transfer protocol options. The listing of selectable options 720 includes “EMT”, “EFT”, and “Wire Transfer”. It will be noted that the listing of selectable options includes at least an option having a high rank (see FIG. 6). It will be further noted that the rank of each of the one or more additional transfer protocol options is above a certain threshold. In the example of FIG. 8, the certain threshold may be, for example, a rank of 4 or a rank of 5 (see FIG. 6).

In this way, the system may provide, to a client device associated with the first storage location, a filtered listing of transfer protocol options representing low-carbon transfer protocol options. The listing may be provided after determining that the first location is associated with a request to suppress one or more transfer protocol options having a low environmental score, and in response to receiving an instruction to display a listing of one or more transfer protocol options.

As noted with reference to FIG. 5, in a second set of embodiments, the user interface data of the operation 510 may be configured to cause a client device 140 (FIG. 1) associated with the first storage location to display a first notification. In at least some implementations of the second set of embodiments, the first notification may identify at least the second transfer protocol option.

In at least some implementations of the second set of embodiments, the display of a first notification is associated with examples where detecting the event (operation 506) includes receiving an instruction to transfer data resources from the first storage location using the first transfer protocol option. The notification may identify at least the second transfer protocol option, the second transfer protocol option having a relatively high rank.

Reference is now made to FIG. 8, which illustrates a second example user interface 800 including a first notification 830, in accordance with embodiments of the present disclosure. As illustrated by FIG. 8, the display 410 of the client device 140 may present the second example user interface 800. The second example user interface 800 displays a title, “Transfer Resources Confirmation” and displays an indication that a transfer amount of 1200.00 data resources is to be transferred from a “First Storage Location” to a “Second Storage Location”. The second example user interface further displays an indication of a selected “Transfer Protocol Option” of “Bank Draft”. The first notification 830 is displayed near the indication of the “Transfer Protocol Option” of “Bank Draft”. The notification 830 recites, “Bank Draft is associated with a relatively low environmental score [10]. Click here to select another option, such as EMT [90], EFT [87], or Wire Transfer [76].” A “CONFIRM” button is displayed beneath the first notification 830.

As will be noted, the first notification 830 identifies one or more additional transfer protocol options of the plurality of transfer protocol options. The rank of each of the one or more additional transfer protocol options is above a certain threshold. In the example of FIG. 8, the certain threshold may be, for example, a rank of 4 or a rank of 5.

In this way, the system may provide, to a client device associated with the first storage location, a first notification identifying at least the second transfer protocol option. The first notification may be provided in response to receiving an instruction to transfer data resources from the first storage location to the second storage location.

In at least some implementations of the second set of embodiments, the display of a second notification is associated with examples where detecting the event (operation 506) includes detecting a transfer of data resources from the first storage location using the first transfer protocol. The second notification may identify at least the second transfer protocol option, the second transfer protocol option having a relatively high rank.

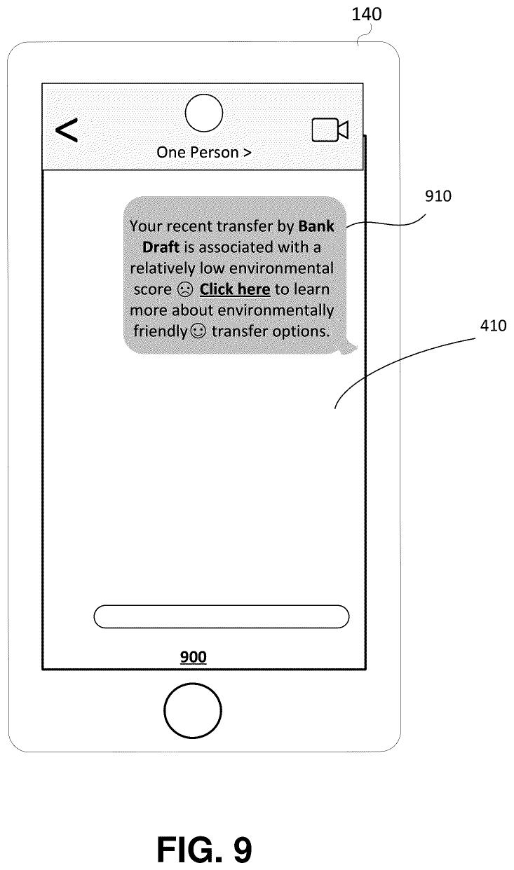

Reference is now made to FIG. 9, which illustrates a third example user interface 900 including a second notification 910, in accordance with embodiments of the present disclosure. As illustrated by FIG. 9, the display 410 of the client device 140 may present the third example user interface 900, which displays the second notification 910. The second notification 910 recites, “Your recent transfer by Bank Draft is associated with a relatively low environmental score. Click here to learn more about environmentally friendly transfer options.”

In this way, the system may provide, to a client device associated with the first storage location, a notification identifying at least the second transfer option. The notification may be provided in response to detecting a transfer of data resources from the first storage location to the second storage location.

As noted with reference to FIG. 5, in a third set of embodiments, the user interface data of the operation 510 may be data configured to facilitate a data resource transfer using the second transfer protocol option.

In at least some implementations of the third set of embodiments, the facilitation of the data resources transfer using the second transfer option may be associated with examples where detecting the event (operation 506) includes receiving an instruction to transfer data resources from the first storage location to a second storage location.

For example, prior to detecting the event (operation 506), the system may determine that the first storage location is associated with a request to automatically select, from the plurality of transfer protocol options, a transfer protocol option having a highest rank.

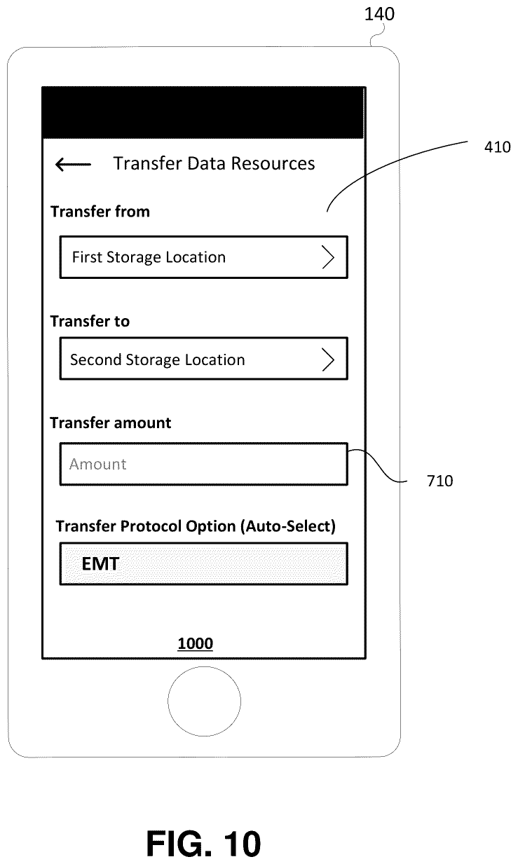

Reference is now made to FIG. 10, which illustrates a fourth example user interface 1000, in accordance with embodiments of the present disclosure. As illustrated by FIG. 10, the display 410 of the client device 140 may present the fourth example user interface 1000. The fourth example user interface 1000 displays a title, “Transfer Data Resources”, and an indication that data resources are to be transferred from a “First Storage Location” to a “Second Storage Location”. The fourth example user interface 1000 further displays a text window 710 for the entry of a desired transfer amount. The fourth example user interface 1000 still further displays an indication that a “Transfer Protocol Option” of EMT has been auto selected.

In this way, the system may initiate a transfer of data resources from the first storage location to the second storage location using the transfer protocol option having the highest rank. The initiation may be provided in response to determining that the first storage location is associated with a request to automatically select, from the plurality of transfer protocol options, a transfer protocol option having a highest rank.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computing system comprising:
a communications module;
a processor coupled to the communications module; and
a first memory coupled to the processor, the first memory storing processor-executable instructions which, when executed, configure the system to:
assign, in a second memory, an environmental score to each of a plurality of transfer protocol options;
determine a rank for each of the plurality of transfer protocol options based on the environmental scores assigned to the plurality of transfer protocol options;
detect an event associated with a first storage location;
in response to detecting the event:
filter the plurality of transfer protocol options to exclude at least a first transfer protocol option having a relatively low rank; and
generate user interface data identifying at least a second transfer protocol option, the second transfer protocol option having a relatively high rank.

2. The computing system of claim 1, wherein detecting the event includes receiving an instruction to display a listing of one or more transfer protocol options, and wherein the system is further caused to provide the user interface data to a client device associated with the first storage location, the user interface data causing the client device to display a user interface that includes a listing of selectable options, the listing of selectable options including at least the second transfer protocol option.

3. The computing system of claim 2, wherein the listing of selectable options further includes one or more additional transfer protocol options of the plurality of transfer protocol options, and wherein the rank of each of the one or more additional transfer protocol options is above a certain threshold.

4. The computing system of claim 2, wherein prior to detecting the event, the system is further caused to:
determine that the first storage location is associated with a request to suppress, from the listing of selectable options, one or more transfer protocol options having a low environmental score.

5. The computing system of claim 1, wherein detecting the event includes receiving an instruction to transfer data resources from the first storage location using the first transfer protocol option, and wherein the system is further caused to provide the user interface data to a client device associated with the first storage location, the user interface data causing the client device to display a notification identifying at least the second transfer protocol option.

6. The computing system of claim 5, wherein the notification further identifies one or more additional transfer protocol options of the plurality of transfer protocol options, and wherein the rank of each of the one or more additional transfer protocol options is above a certain threshold.

7. The computing system of claim 1, wherein detecting the event includes receiving an instruction to transfer data resources from the first storage location to a second storage location, and wherein the system is further caused to:
provide the user interface data to a client device associated with the storage first location, and
initiate a transfer of the data resources from the first storage location to the second storage location using the second transfer protocol option, wherein the rank of the second transfer protocol option is equal to one.

8. The computing system of claim 7, wherein prior to detecting the event, the system is further caused to:
determine that the first storage location is associated with a request to automatically select, from the plurality of transfer protocol options, a transfer protocol option having a highest rank.

9. The computing system of claim 1, wherein detecting the event includes detecting a transfer of data resources from the first storage location using the first transfer protocol option, and wherein the system is further caused to:
provide the user interface data to a client device associated with the first storage location, the user interface data causing the client device to display a notification identifying at least the second transfer protocol option.

10. The computing system of claim 1, wherein the environmental score assigned to each of the plurality of transfer protocol options is based upon an expected carbon footprint associated with use of each of the plurality of transfer protocol options.

11. The computing system of claim 10, wherein the expected carbon footprint is based upon one or more of an expected number of persons required to effect each of the transfer protocol options, an expected amount of transportation required to effect each of the transfer protocol options, or an expected use of biometric authentication associated with each of the transfer protocol options.

12. A computer-implemented method comprising:
assigning, in a memory, an environmental score to each of a plurality of transfer protocol options;
determining a rank for each of the plurality of transfer protocol options based on the environmental scores assigned to the plurality of transfer protocol options;
detecting an event associated with a first storage location;
in response to detecting the event:
filtering the plurality of transfer protocol options to exclude at least a first transfer protocol option having a relatively low rank; and
generating user interface data identifying at least a second transfer protocol option, the second transfer protocol option having a relatively high rank.

13. The method of claim 12, wherein detecting the event includes:
receiving an instruction to display a listing of one or more transfer protocol options, and wherein the method further comprises providing the user interface data to a client device associated with the first storage location, the user interface data causing the client device to display a user interface that includes a listing of selectable options, the listing of selectable options including at least the second transfer protocol option.

14. The method of claim 13, wherein the listing of selectable options further includes one or more additional transfer protocol options of the plurality of transfer protocol options, and wherein the rank of each of the one or more additional transfer protocol options is above a threshold.

15. The method of claim 13, wherein prior to detecting the event, the method further comprises:
determining that the first storage location is associated with a request to suppress, from the listing of selectable options, one or more transfer protocol options having a low environmental score.

16. The method of claim 12, wherein detecting the event includes receiving an instruction to transfer data resources from the first storage location using the first transfer protocol option, and wherein the method further comprises providing the user interface data to a client device associated with the first storage location, the user interface data causing the client device to display a notification identifying at least the second transfer protocol option.

17. The method of claim 16, wherein the notification further identifies one or more additional transfer protocol options of the plurality of transfer protocol options, and wherein the rank of each of the one or more additional transfer protocol options is above a threshold.

18. The method of claim 12, wherein detecting the event includes receiving an instruction to transfer data resources from the first storage location to a second storage location, and
wherein the method further comprises:
providing the user interface data to a client device associated with the storage first location; and
initiating a transfer of the data resources from the first storage location to the second storage location using the second transfer protocol option, wherein the rank of the second transfer protocol option is equal to one.

19. The method of claim 18, wherein prior to detecting the event, the method further comprises:
determining that the first storage location is associated with a request to automatically select, from the plurality of transfer protocol options, a transfer protocol option having a highest rank.

20. A non-transitory computer-readable storage medium comprising processor-executable instructions which, when executed, configure a processor to:
assign, in a memory, an environmental score to each of a plurality of transfer protocol options;
determine a rank for each of the plurality of transfer protocol options based on the environmental scores assigned to the plurality of transfer protocol options;
detect an event associated with a first storage location;
in response to detecting the event:
filter the plurality of transfer protocol options to exclude at least a first transfer protocol option having a relatively low rank; and
generate user interface data identifying at least a second transfer protocol option, the second transfer protocol option having a relatively high rank.
